(19) United States
(12) Patent Application Publication
(10) Pub. No.: US 2020/0304383 A1
(43) Pub. Date: Sep. 24, 2020

(54) GENERATION OF TEMPLATES FOR CLOUD COMPUTING PLATFORMS

(71) Applicant: Hewlett Packard Enterprise Development LP, Houston, TX (US)

(72) Inventors: Ajay Kumar Bajaj, Bangalore Karnataka (IN); Prabhu Murthy, Bangalore Karnataka (IN); Abhishek Kumar, Bangalore Karnataka (IN)

(21) Appl. No.: 16/357,742

(22) Filed: Mar. 19, 2019

(51) Int. Cl. H04L 12/24

(52) U.S. Cl. CPC H04L 41/5048; H04L 41/0843

(57) ABSTRACT

Examples of generation of templates for cloud computing platforms are disclosed. In an example, a plurality of service provider specific parameters corresponding to a selected parameter is identified. Each of the plurality of service provider specific parameters is associated with a respective cloud service provider. A plurality of service provider specific templates for deployment and management of the computing entity over the plurality of cloud computing platforms is generated, based on the plurality of service provider specific parameters. Each of the plurality of service provider specific templates includes a corresponding service provider specific parameter, from the plurality of service provider specific parameters.

### BACKGROUND

Computing entities, such as compute nodes, virtual machine instances, databases, virtual servers, virtual networks, containers, resource groups may be deployed in cloud computing platforms. A cloud computing platform may be implemented in a cloud infrastructure having hardware and software components, such as servers, storage, a network, and virtualization tools. The computing entities may be deployed and managed in the cloud computing platform through cloud orchestration techniques which automate collections of tasks and streamlines processes in a workflow.

Cloud orchestration may be performed using resource management templates, also referred to as templates, which define components of the cloud infrastructure, for example, a database server, a network address, a storage volume, etc., for deployment of the computing entities. The template may also specify parameters for deployment of the computing entities in the cloud computing platform, where the parameters define configuration of the computing entities to be deployed and managed. Templates allow simpler deployment, convenient replication, and simpler management of the computing entities in the cloud computing platform.

### BRIEF DESCRIPTION OF DRAWINGS

The following detailed description references the drawings, wherein:

FIG. 1 illustrates a system for generation of templates for cloud computing platforms, according to an example;

FIG. 2 illustrates a system for generation of templates for cloud computing platforms, according to an example;

FIG. 3 illustrates a method for generation of templates for cloud computing platforms, according to an example;

FIG. 4 illustrates a method for generation of templates for cloud computing platforms, according to an example;

FIG. 5 illustrates a system environment implementing a non-transitory computer-readable medium for generation of templates for cloud computing platforms, according to an example.

### DETAILED DESCRIPTION

A cloud service provider has a resource management template, also called a template, for deployment of computing entities in a cloud computing platform hosted by the cloud service provider. The template defines components of a cloud infrastructure over which the computing entities are to be deployed. In an example, the template is a computer file that includes information of parameters for deployment and management of computing entities in the cloud computing platform in JavaScript Object Notation (JSON) format. The parameters may define configuration settings of the computing entities to be deployed and managed in the cloud computing platform. A network administrator may provide values for the parameters for deployment and management of the computing entities in the cloud computing platform. Based on the values of the parameters in the template, the computing entities may be deployed and managed in the cloud computing platform.

Each cloud service provider has a respective resource management template. The resource management template of a cloud service provider may be incompatible in a cloud computing platform hosted by a different cloud service provider. Thus, when multiple computing entities with similar configuration are to be deployed in multiple cloud computing platforms hosted by different cloud service providers, the network administrator provides user inputs corresponding to values of the parameters in respective templates of each cloud service provider. Providing the values of the parameters in the respective templates of each cloud service provider separately, may be time consuming, complex and involves manual effort. Thus, deploying computing entities in multiple cloud computing platforms hosted by different cloud service providers, simultaneously, may be complex and time consuming.

According to the present disclosure, information about the parameters for deploying the computing entities is received from a network administrator and the information is used to generate templates specific to each of the cloud service providers. Based on the generated templates, the computing entities may be deployed in respective cloud computing platforms. Thus, values of parameters for deployment of computing entities in multiple cloud computing platforms hosted by different cloud service providers, may be provided in a consolidated manner at one place. Based on the provided values, different templates associated with different cloud service providers may be generated for deploying the computing entities in respective cloud computing platforms hosted by the different cloud service providers.

The present disclosure describes method(s) and system(s) in which a parameter, from amongst a plurality of parameters, is selected. The plurality of parameters is indicative of information associated with a computing entity to be deployed and managed over a plurality of cloud computing platforms, where each of the plurality of cloud computing platforms is hosted by a cloud service provider, from amongst a plurality of cloud service providers. The information indicated by the parameters may define configuration settings of the computing entity to be deployed and managed in the cloud computing platforms. The parameters may also define cloud infrastructure components over which the computing entity may be deployed. The cloud infrastructure components may include hardware components and applications which provide compute, storage, and networking capabilities to cloud computing platforms.

A plurality of service provider specific parameters corresponding to the parameter is identified. Each of the plurality of service provider specific parameters is associated with a respective cloud service provider. A service provider specific parameter is indicative of information associated with the computing entity to be deployed and managed over a cloud computing platform hosted by a cloud service provider with which the service provider specific parameter is associated. The information indicated by the service provider specific parameter may define configuration settings of the computing entity to be deployed and managed.

Based on the plurality of service provider specific parameters, a plurality of service provider specific templates for deployment and management of the computing entity over the plurality of cloud computing platforms may be identified. Each of the plurality of service provider specific templates includes a corresponding service provider specific parameter, from the plurality of service provider specific parameters. The service provider specific templates enable deployment and management of the computing entity in multiple cloud computing platforms, by execution of respective service provider specific templates.

According to the present disclosure, the service provider specific templates with corresponding service provider specific parameters are generated from information of a parameter provided in consolidated manner at one place. Thus, separate service provider specific templates may not be launched, and the values of the parameters may not be populated in each service provide specific template separately. Consequently, the manual effort of the network administrator may be reduced and computing entities may be launched over multiple cloud computing platforms hosted by different cloud service providers in a simpler manner.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

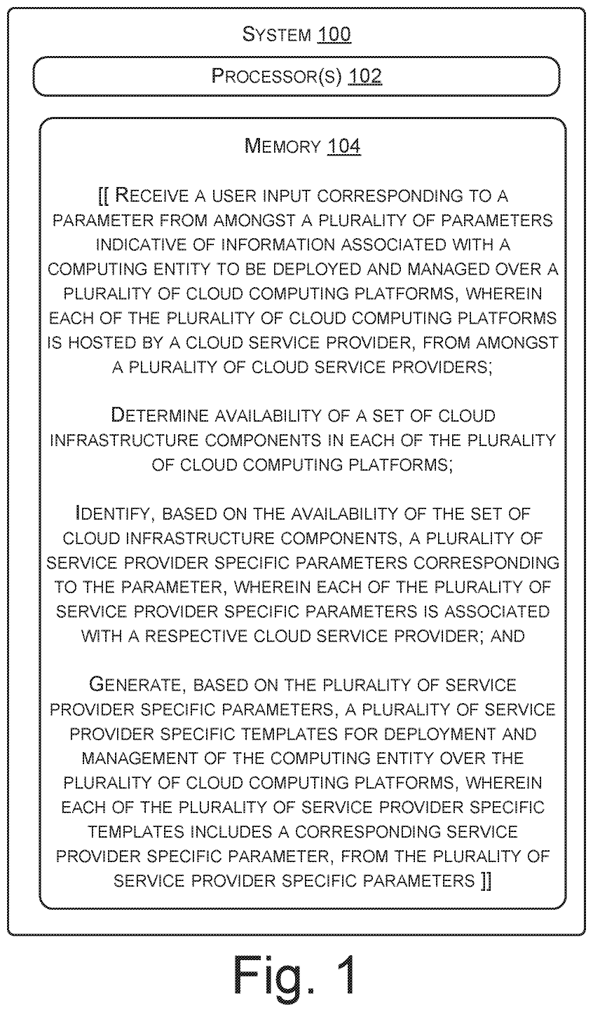

FIG. 1 illustrates a system 100 for generation of templates for cloud computing platforms. The system 100 may be a computing resource having data processing, storage, and networking capabilities. Examples of the system 100 include personal computers, laptops, enterprise servers, embedded systems, or the like. In an example, the system 100 may be implemented through a cloud monitoring and management platform that can monitor and manage computing resources connected over a cloud network. The system 100 may be connected to other computing resources over a network, such as the Internet, a Local Area Network, a virtual network, and a combination thereof.

The system 100 includes a processor 102 and a memory 104 coupled to the processor 102. The memory 104 stores instructions executable by the processor 102. The instructions when executed by the processor 102 may cause the processor 102 to receive a user input corresponding to a parameter from amongst a plurality of parameters. The plurality of parameters is indicative of information associated with a computing entity to be deployed and managed over a plurality of cloud computing platforms. The computing entity refers to applications and services that may be launched in a cloud computing platform to perform predefined functions. Examples of the computing entity include one of a compute node, a storage volume, a virtual network, a virtual machine, and a resource group container.

Each of the plurality of cloud computing platforms is hosted by a cloud service provider, from amongst a plurality of cloud service providers. Thus, different cloud computing platforms may be hosted by different cloud service providers. The plurality of cloud service providers may provide different cloud infrastructures for hosting cloud computing platforms.

The information associated with the computing entity is representative of configuration of the computing entity which is to be deployed over the cloud computing platforms. Examples of the parameters include a resource information indicative of a type of computing entity to be deployed and managed, a server information indicative of capabilities of a server in which the computing entity is to be deployed, a virtual machine image information, a flavor information indicative of hardware configuration associated with the computing entity, a network configuration associated with computing entity, a security group information indicative of firewall settings associated with the computing entity, a protocol information associated with computing entity, and a combination thereof.

In an example, the instructions when executed by the processor 102 may cause the processor 102 to select a parameter from amongst the plurality of parameters. In an example, the parameter may be selected, in response to receiving a user input identifying a value of the parameter. The user input may be provided by a network administrator.

The instructions when executed by the processor 102 further cause the processor 102 to determine availability of a set of cloud infrastructure components in each of the plurality of cloud computing platforms. The set of cloud infrastructure components refer to hardware components and applications in each of the cloud computing platforms.

In response to determining that the set of cloud infrastructure components are available in the cloud computing platforms, a plurality of service provider specific parameters corresponding to the parameter is identified. Service provider specific parameters refer to parameters which may form a part of a resource manager template of a cloud computing platform hosted by a specific cloud service provider. Thus, each service provider specific parameter is associated with a respective cloud service provider.

The instructions when executed by the processor 102 further cause the processor 102 to generate a plurality of service provider specific templates for deployment and management of the computing entity over the plurality of cloud computing platforms, based on the plurality of service provider specific parameters. The service provider specific templates refer to resource management templates associated with the cloud service providers. Each of the service provider specific templates includes a corresponding service provider specific parameter, from the service provider specific parameters. Thus, the present disclosure enables generation of different service provider specific templates from information regarding parameters provided by the network administrator in a consolidated manner at one place thereby eliminating manual effort of the network administrator in populating values of the parameters in each service provider specific template, individually.

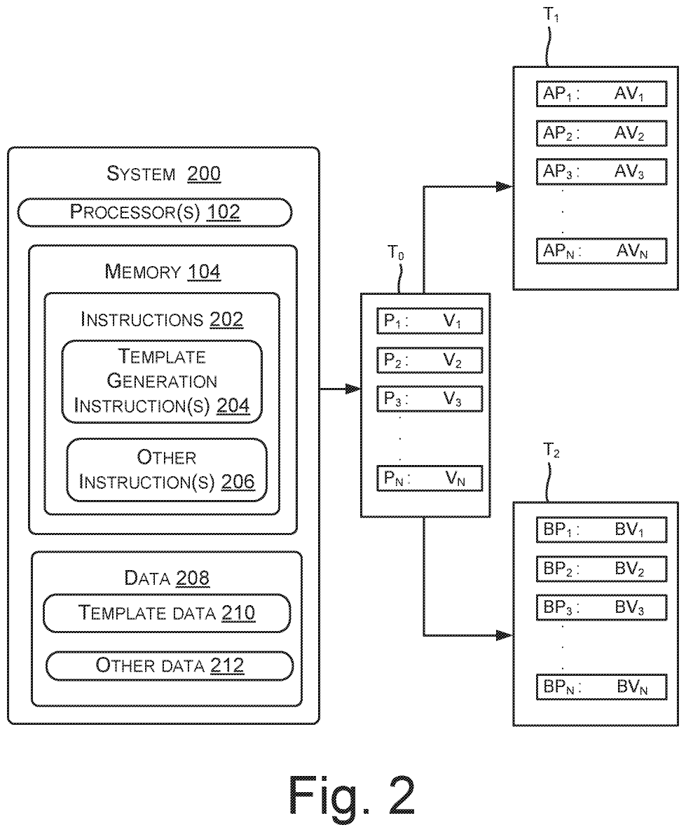

FIG. 2 illustrates a system 200 for generation of templates for deployment and management in cloud computing platforms, according to an example of the present subject matter. In an example, the system 200 may be implemented in a cloud management platform in a cloud environment. The system 200 may also be implemented within a computing entity launched in a cloud computing platform. Examples of the computing entity includes one of a compute node, a storage volume, a virtual network, a virtual machine, and a resource group container.

The system 200 includes the processor 102 and the memory 104 coupled to the processor 102. The memory 104 stores instructions executable by the processor 102. The processor 102 may be implemented as microprocessors, microcomputers, microcontrollers, digital signal processors, central processing units, state machines, logic circuitries, and any devices that manipulate signals based on operational instructions. Among other capabilities, the processor 102 is configured to fetch and execute computer-readable instructions stored in the memory 104. The computer-readable instructions, also referred to as instructions, includes instructions 202. The instructions 202 may include routines, programs, components, applications, data structures, and the like, which perform particular tasks or implement particular abstract data types. The instructions, being executable by the processor(s), may also be referred to as processor-executable instructions. The execution of the instructions to perform a function may be interchangeably referred to as the instructions causing performance of the function or the instructions enabling performance of the function.

The functions of the various elements shown in the FIG. 2, including any functional blocks labeled as “processor(s)”, may be provided through the use of dedicated hardware as well as hardware capable of executing software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other custom-built hardware, may also be included.

The memory 104 may include any computer-readable medium known in the art including, for example, volatile memory (e.g., RAM), and/or non-volatile memory (e.g., EPROM, flash memory, etc.). The instruction(s) 202 include template generation instruction(s) 204 which corresponds to instructions stored on a computer-readable medium and executable by a processor to generate service provider specific templates. The instruction(s) 202 also comprise other instruction(s) 206 that supplement applications on the system 200, for example, execution of functions of an operating system.

Data 208 serves, amongst other things, as a repository for storing data that may be fetched, processed, received, or generated during execution of the instruction(s) 202 by the processor 102. The data 208 comprises template data 210 which stores data relating to service provider specific templates. The data 208 also comprises other data 212 that may be fetched, processed, received, or generated during execution of other instruction(s) 206.

Consider that a network administrator intends to generate service provider specific templates associated with two different cloud service providers for deployment of computing entities over two cloud computing platforms hosted by the two cloud service providers. The cloud computing platforms hosted by the two cloud service providers may also be referred to as cloud A and cloud B (not shown in FIG. 2). Cloud A may be hosted by a first cloud service provider and cloud B may be hosted by a second cloud service provider. Although FIG. 2 is illustrated in respect of generation of service provider specific templates corresponding to two cloud computing platforms hosted by two different cloud service providers, service provider specific templates corresponding to more than two cloud computing platforms may also be generated.

During operation, the template generation instructions 204 when executed by the processor 102, cause the processor 102 to receive a user input corresponding to each of a plurality of parameters. The plurality of parameters is indicative of information associated with a computing entity to be deployed and managed over the plurality of cloud computing platforms, viz., cloud A and cloud B. In an example, in response to receiving a user input for initiating generation of templates, the template generation instructions 204 may cause a Command Line Interface (CLI) or Graphical User Interface (GUI) to be launched in the system 200. In an example, the CLI/GUI may provide a template file that may include information of parameters for deployment and management of computing entities in the cloud computing platforms in JavaScript Object Notation (JSON) format. A network administrator may provide user inputs defining values of the parameters in the template file. The template file is also referred to as a unified template file.

With reference to FIG. 2, ‘T₀’ illustrates a view of the unified template file generated on execution of the template generation instructions 204, in response to receiving the user input for initiating generation of templates. P₁, P₂, P₃, . . . , P_{N} represent the plurality of parameters, also referred to as parameters P. Consider that a network administrator populates values V₁, V₂, V₃, . . . , V_{N}, also referred to as values V, corresponding to the plurality of parameters P. Thus, the values V are associated with the parameters P based on an user input. In an example, the values V provide configuration information for launching the computing entity. In an example, an undefined value may be associated with a parameter. An undefined value may be a garbage value or error value which may get assigned to a parameter due to erroneous user inputs. In an example, a value may be treated as undefined if it indicates a technically unsupported value for the parameter. In response to determining that an undefined value is associated with a parameter, from the parameters P, a message indicating an error in the user input may be generated. In an example, one parameter or more than one parameter, from amongst the parameters P, may be identified as mandatory parameters. The mandatory parameters are those parameters, among the parameters P, for which user inputs are to be compulsorily provided for generation of service provider specific templates.

In response to respective values being assigned to the parameters P, the template generation instructions 204 may cause the processor 102 to select a parameter, from amongst the parameters P. In an example, the template generation instructions 204 may enable selection of the parameter, in response to values being assigned to the mandatory parameters. In an example, the template generation instructions 204 may enable selection of the parameter in response to a user input identifying the parameter. Consider that the parameter P₁ is selected. Although the operation, hereinafter is explained with reference to the parameter P₁, in an example any other parameter from the parameters P may be processed in a similar manner. In an example, the parameter P₁ may be one of a resource information indicative of a type of computing entity to be deployed and managed, a server information indicative of capabilities of a server in which the computing entity is to be deployed, a virtual machine image information, a flavor information indicative of hardware configuration associated with the computing entity to be deployed, a network configuration associated with computing entity, a security group information indicative of firewall settings associated with the computing entity, a protocol information associated with the computing entity, and a combination thereof.

In response to the parameter P₁ being selected, the template generation instructions 204 may cause the processor 102 to determine availability of a set of cloud infrastructure components in each of the plurality of cloud computing platforms, A and B. The set of cloud infrastructure components include hardware and software components for deployment of the computing entity in the cloud computing platforms A and B. In an example, the availability of the set of cloud infrastructure components may be determined by collecting data relating to processing and memory resources in the cloud computing platforms A and B from respective cloud controllers of the cloud computing platforms A and B.

In response to determining that the set of cloud infrastructure components is unavailable in a cloud computing platform, from the plurality of cloud computing platforms A and B, the template generation instructions 204 may cause the processor 102 to generate a message indicating failure to generate a service provider specific template for cloud orchestration in the cloud computing platform.

In response to determining that the set of cloud infrastructure components is available in the cloud computing platforms, a relevance of the parameter P₁ for generation of a service provider specific template, from amongst the plurality of service provider specific templates, is determined. With reference to FIG. 2, all the parameters P may not be supported by the cloud computing platforms A and B. Each of the cloud computing platforms A and B, has a list of predefined set of parameters supported by them. The parameter P₁ is compared with the list of predefined set of parameters supported by clouds A and B to determine the relevance of the parameter P₁. On determining that cloud A has a service provider specific parameter corresponding to the parameter P₁, the parameter P₁ is identified to be relevant and is associated with the corresponding service provider specific parameter. Associating the parameter P₁ with the corresponding service provider specific parameter includes assigning the value V₁ of the parameter P₁ to the corresponding service provider specific parameter. In an example, the corresponding service provider specific parameter may be extracted from the list of predefined set of parameters supported by the clouds A and B.

With reference to FIG. 2, in response to determining that the parameter P₁ is relevant for generation of a service provider specific template for cloud A, the template generation instructions 204 may cause the processor 102 to associate the parameter P₁ with the corresponding service provider specific parameter for the cloud A. In response to determining that the parameter P₁ is relevant for generation of a service provider specific template for cloud B, the template generation instructions 204 may cause the processor 102 to associate the parameter P₁ with a corresponding service provider specific parameter for the cloud B.

In an example, in response to determining that the parameter P₁ is irrelevant for generation of the service provider specific template for cloud A, a default value may be assigned to the parameter P₁. In an example, the default value may be null. In this manner, a plurality of service provider specific parameters corresponding to the parameter P₁ may be identified, where each of the plurality of service provider specific parameters is associated with a respective cloud service provider hosting the cloud computing platforms, such as clouds A and B. Similarly, for each of the parameters P₁, P₂, P₃, . . . P_{N}, a corresponding service provider specific parameter is identified.

With reference to FIG. 2, a service provider specific parameter for cloud A corresponding to parameter P₁ is AP₁ and a service provider specific parameter for cloud B corresponding to parameter P₁ is BP₁. As the corresponding service provider specific parameters AP₁ and BP₂ are identified, the template generation instructions 204 causes the processor 102 to assign values AV₁ and BV₂ to service provider specific parameters AP₁ and BP₁, respectively. The service provider specific parameters identified for cloud A, corresponding to parameters P₁, P₂, P₃, . . . , and P_{N} are AP₁, AP₂, AP₃, . . . , and AP_{N}, also referred to as parameters AP. The values assigned to the parameters AP₁, AP₂, AP₃, . . . , and AP_{N}, are AV₁, AV₂, AV₃, . . . , and AV_{N}, respectively, also referred to as a values AV.

Similarly, the service provider specific parameters identified for cloud B, corresponding to parameters P₁, P₂, P₃, . . . , and P_{N} are BP₁, BP₂, BP₃, . . . , and BP_{N}, also referred to as parameters BP for cloud B. The values assigned to the parameters BP₁, BP₂, BP₃, . . . , and BP_{N}, are BV₁, BV₂, BV₃, . . . , and BV_{N}, respectively, also referred to as a values BV.

Once the service provider specific parameters for clouds A and B corresponding to each of parameters P are identified, the template generation instructions 204 may cause the processor 102 to generate a plurality of service provider specific templates for deployment and management of the computing entity over the plurality of cloud computing platforms, based on the plurality of service provider specific parameters. In an example, generating the service provider specific templates for deployment and management of the computing entity over the plurality of cloud computing platforms, such as a cloud A, includes collating the service provider specific parameters for cloud A in a template file, also called the service provider specific template for cloud A.

With reference to FIG. 2 the service provider specific template for cloud A is referenced as T₁. The service provider specific parameters AP for cloud A are combined in the service provider specific template T₁ for cloud A. The respective values AV for the service provider specific parameters AP are also included in the template T₁. The service provider specific template for cloud B is referenced as T₂. The service provider specific parameters BP for cloud B are combined in the service provider specific template T₂ for cloud B. The respective values BV for the service provider specific parameters BP are also included in the template T₂. Thus, each of the plurality of service provider specific templates includes a corresponding service provider specific parameter, from the plurality of identified service provider specific parameters. Each of the plurality of service provider specific templates, such as templates, T₁ and T₂ includes configuration information of the computing entity for cloud orchestration in a cloud computing platform, such as cloud A or cloud B.

In an example, the template generation instructions 204 may enable the processor 102 to determine respective cost estimates for deployment of the computing entity in the plurality of cloud computing platforms A and B. In an example, on receiving a user input to view cost estimates of deployment of the computing entity in the clouds A and B, the template generation instructions 204 may cause the processor 102 to fetch a deployment cost information associated with each of the clouds A and B. In an example, the deployment cost information may be a cost structure providing the cost for deployment of a computing entity in a cloud computing platform, such as the cloud A and B. In an example, the deployment cost information may provide costs for deploying computing entities, such as, VM instances, virtual servers, virtual networks, resource group containers, storage volumes, etc., depending on processing and memory resources to be allocated to the computing entities and rates applicable for the cloud computing platform.

With reference to FIG. 2, a cost estimate for deploying the computing entity in cloud A may be determined based on deployment cost information of cloud A and the service provider specific templates T₁. A cost estimate for deploying the computing entity in cloud B may be determined based on deployment cost information of cloud B and the service provider specific templates T₂. Thus, the respective cost estimates for deployment of the computing entity in the plurality of cloud computing platforms, may be generated based on deployment cost information of each of the plurality of cloud service providers and the plurality of service provider specific templates.

Once the plurality of service provider specific templates T₁ and T₂ are generated, the template generation instructions 204 may cause the processor 102 to execute each of the plurality of service provider specific templates, viz., T₁ and T₂. In response to execution of each of the plurality of service provider specific templates, the template generation instructions 204 cause the processor 102 to deploy the computing entity in each of the plurality of cloud computing platforms A and B.

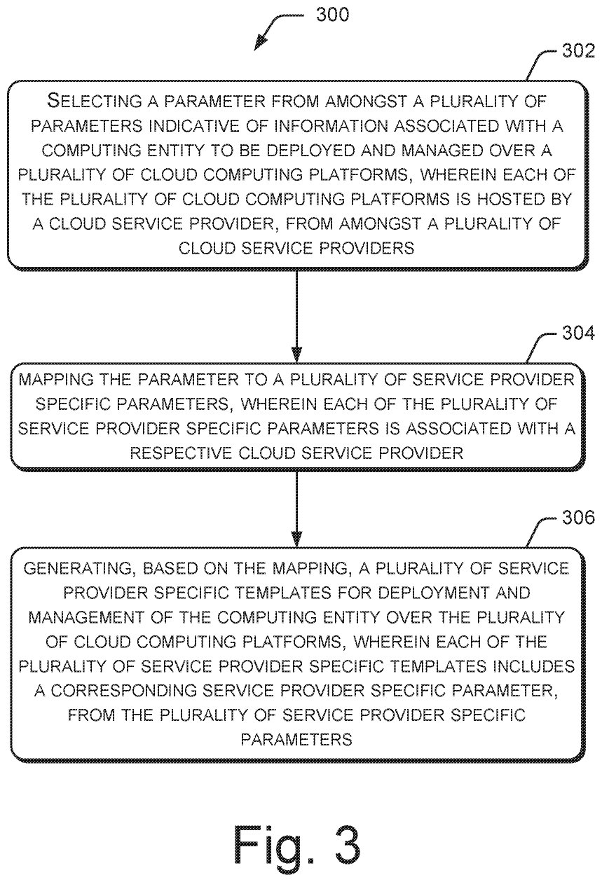

FIG. 3 illustrates a method 300 for generation of templates for deployment and management in cloud computing platforms, according to an example. The method 300 may be executed by a system, such as the system 100 or 200. The method 300 can be implemented by processing resource(s) or computing device(s) through any suitable hardware, a non-transitory machine readable medium, or combination thereof. In an example, step(s) of the method 300 may be performed by execution of computer-readable instructions, such as the template generation instructions 204 which includes instructions stored on a medium and executable by a processing resource, such as the processor 102, of a system, such as the system 100 or 200. Further, although the method 300 is described in context of the aforementioned system 100 or 200, other suitable systems may be used for execution of the method 300. It may be understood that processes involved in the method 300 can be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 3, at block 302, a parameter, from amongst a plurality of parameters, is selected. The plurality of parameters is indicative of information associated with a computing entity to be deployed and managed over a plurality of cloud computing platforms. Each of the plurality of cloud computing platforms is hosted by a cloud service provider, from amongst a plurality of cloud service providers. Examples of the plurality of parameters include a resource information indicative of a type of computing entity to be deployed and managed, a server information indicative of capabilities of a server in which the computing entity is to be deployed, a virtual machine image information, a flavor information indicative of hardware configuration associated with the computing entity, a network configuration associated with computing entity, a security group information indicative of firewall settings associated with the computing entity, a protocol information associated with computing entity, and a combination thereof. Examples of the computing entity includes one of a compute node, a storage volume, a virtual network, a virtual machine, and a resource group container.

At block 304, a plurality of service provider specific parameters corresponding to the parameter is identified. Each of the plurality of service provider specific parameters is associated with a respective cloud service provider.

At block 306, a plurality of service provider specific templates for deployment and management of the computing entity over the plurality of cloud computing platforms are generated, based on the plurality of service provider specific parameters. Each of the plurality of service provider specific templates includes a corresponding service provider specific parameter, from the plurality of service provider specific parameters.

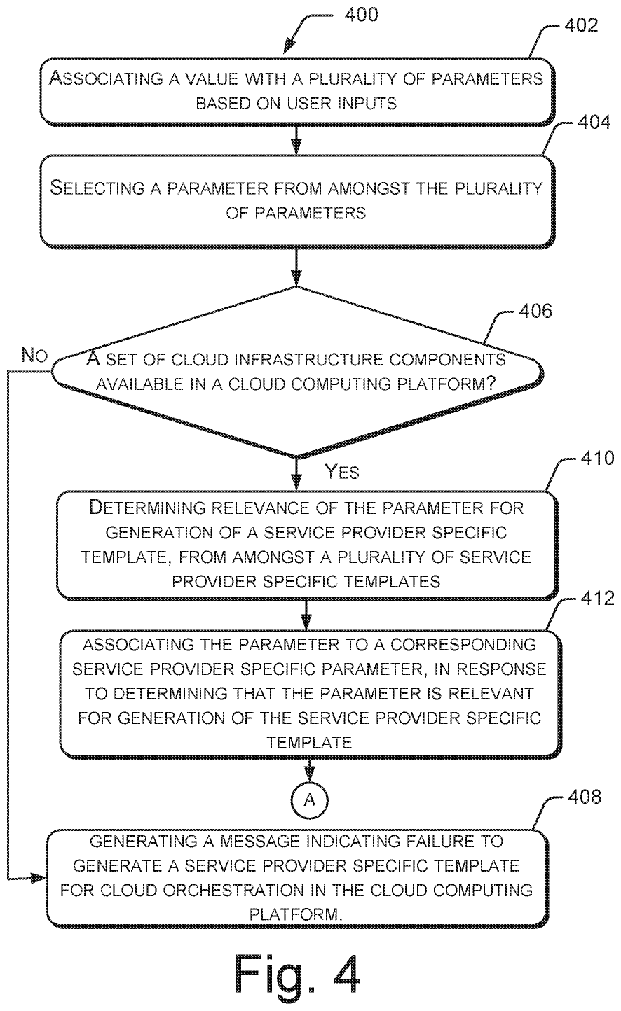

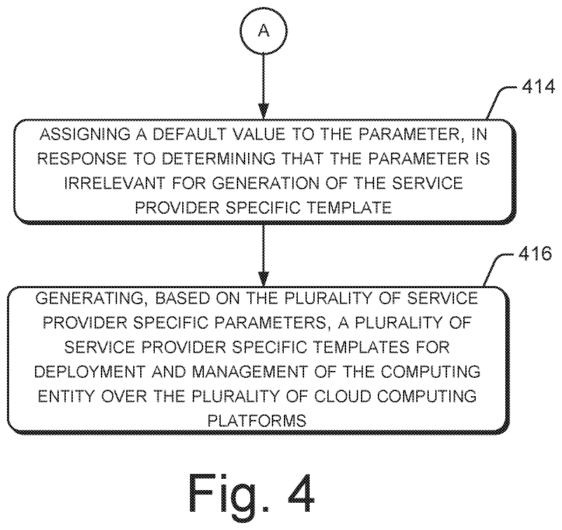

FIG. 4 illustrates a method 400 for generation of templates for deployment and management in cloud computing platforms, according to an example. The method 400 may be executed by a system, such as the system 100 or 200. The method 400 can be implemented by processing resource(s) or computing device(s) through any suitable hardware, a non-transitory machine readable medium, or combination thereof. In an example, the method 400 may be performed by computer-readable instructions, such as the template generation instructions 204 which include instructions stored on a medium and executable by a processing resource, such as the processor 102, of a system, such as the system 100 or 200. Further, although the method 400 is described in context of the aforementioned system 100 or 200, other suitable systems may be used for execution of the method 400. It may be understood that processes involved in the method 400 can be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 4, at block 402, a value is associated with a parameter, from amongst a plurality of parameters, based on a user input. The plurality of parameters may be similar to the parameters P, as described in the description of FIG. 2. The plurality of parameters is indicative of information associated with a computing entity to be deployed and managed over a plurality of cloud computing platforms, such as the clouds A and B as exemplified in the description of FIG. 2, where each of the cloud computing platforms is hosted by a cloud service provider, from amongst a plurality of cloud service providers. In an example, if an undefined value is associated with the parameter, a message may be generated indicating an error in the user input. In an example, user inputs defining values of each of the plurality of parameters are received.

At block 404, a parameter, such as the parameter P1 of FIG. 2, is selected from amongst the plurality of parameters.

At block 406, availability of a set of cloud infrastructure components in each of the plurality of cloud computing platforms is determined. The availability of the set of cloud infrastructure components indicate memory and processing capabilities of the cloud computing platforms.

In response to determining that the set of cloud infrastructure components is unavailable in a cloud computing platform (‘No’ branch from block 406), a message indicating failure to generate a service provider specific template for cloud orchestration in the cloud computing platform is generated, at block 408.

In response to determining that the set of cloud infrastructure components is available in a cloud computing platform (‘Yes’ branch from block 406), a relevance of the parameter for generation of a service provider specific template is determined, at block 410. A service provider specific template refers to a template file supported by a particular cloud computing platform hosted by a particular cloud service provider. Relevance of the parameter is indicative of presence of a corresponding service provider specific parameter in a cloud computing platform.

In response to determining that the parameter is relevant for generation of the service provider specific template, the parameter is associated to a corresponding service provider specific parameter, at block 412. In response to determining that the parameter is irrelevant for generation of the service provider specific template, a default value may be assigned to the parameter, service provider specific templates, at block 414. Thus, the plurality of service provider specific parameters corresponding to the parameter is identified.

At block 416, a plurality of service provider specific templates may be generated, for deployment and management of the computing entity over the plurality of cloud computing platforms based on the plurality of service provider specific parameters. In an example, the service provider specific templates may be generated by collating the corresponding service provider specific parameters for the cloud computing platform.

In an example, once the service provider specific templates are generated for respective cloud computing platforms, respective cost estimates for deployment of the computing entity in the cloud computing platforms may be generated, based on deployment cost information of each of the plurality of cloud service providers which host the cloud computing platforms and the plurality of service provider specific templates.

In an example, the generated service provider specific templates may be executed in their respective cloud computing platforms. In response to execution of the service provider specific templates, the computing entity may be deployed in each of the cloud computing platforms.

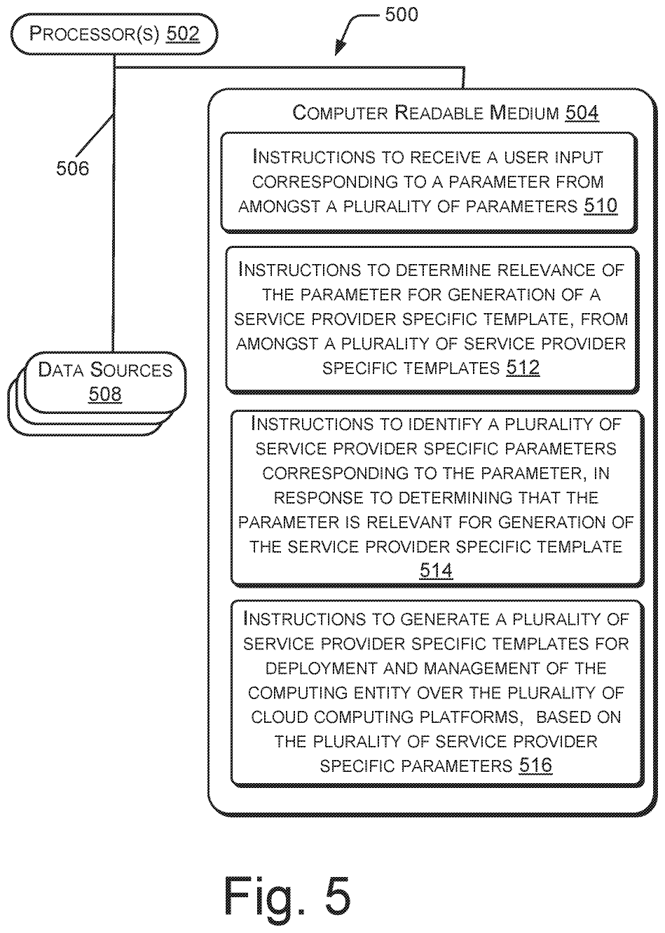

FIG. 5 illustrates a system environment 500 implementing a non-transitory computer-readable medium for generation of templates for cloud computing platforms, according to an example. In an example, the system environment 500 includes processor(s) 502 communicatively coupled to a non-transitory computer-readable medium 504 through a communication link 506. In an example, the system environment 500 may be a system, such as the system 100 or 200. In an example, the processor(s) 502 may have one or more processing resources for fetching and executing computer-readable instructions from the non-transitory computer-readable medium 504.

The non-transitory computer-readable medium 504 can be, for example, an internal memory device or an external memory device. In an example implementation, the communication link 506 may be a direct communication link, such as any memory read/write interface.

The processor(s) 502 and the non-transitory computer-readable medium 504 may also be communicatively coupled to data sources 508 over a network, such as the Internet. The data sources 508 can include, for example, memory of the system, such as the system 100 or 200.

In an example implementation, the non-transitory computer-readable medium 504 includes a set of computer-readable instructions which can be accessed by the processor(s) 502 through the communication link 506 and subsequently executed to perform acts for generation of an instruction stream for validating processor functionality.

Referring to FIG. 5, in an example, the non-transitory computer-readable medium 504 includes instructions 510 that cause the processor(s) 502 to receive a user input corresponding to a parameter from amongst a plurality of parameters. The plurality of parameters is indicative of information associated with a computing entity to be deployed and managed over a plurality of cloud computing platforms, where each of the plurality of cloud computing platforms is hosted by a cloud service provider, from amongst a plurality of cloud service providers.

Further, the non-transitory computer-readable medium 504 includes instructions 512 that cause the processor(s) 502 to determine relevance of the parameter for generation of a service provider specific template, from amongst a plurality of service provider specific templates.

The non-transitory computer-readable medium 504 includes instructions 514 that cause the processor(s) 502 to identify a plurality of service provider specific parameters corresponding to the parameter, in response to determining that the parameter is relevant for generation of the service provider specific template. Each of the plurality of service provider specific parameters are associated with a respective cloud service provider.

Further, the non-transitory computer-readable medium 504 includes instructions 516 that cause the processor(s) 502 to generate, based on the plurality of service provider specific parameters, a plurality of service provider specific templates for deployment and management of the computing entity over the plurality of cloud computing platforms. Each of the plurality of service provider specific templates includes a corresponding service provider specific parameter, from the plurality of service provider specific parameters. In an example, each of the plurality of service provider specific templates includes configuration information of the computing entity for cloud orchestration in a cloud computing platform, from amongst the plurality of cloud computing platforms.

Although implementations of present subject matter have been described in language specific to structural features and/or methods, it is to be noted that the present subject matter is not necessarily limited to the specific features or methods described. Rather, the specific features and methods are disclosed and explained in the context of a few implementations for the present subject matter.

1. A method comprising:
selecting a parameter from amongst a plurality of parameters indicative of information associated with a computing entity to be deployed and managed over a plurality of cloud computing platforms, wherein each of the plurality of cloud computing platforms is hosted by a cloud service provider, from amongst a plurality of cloud service providers;
identifying a plurality of service provider specific parameters corresponding to the parameter, wherein each of the plurality of service provider specific parameters is associated with a respective cloud service provider, wherein identifying the plurality of service provider specific parameters corresponding to the parameter comprises:
determining relevance of the parameter for generation of a service provider specific template, from amongst the plurality of service provider specific templates; and
assigning a default value to the parameter, in response to determining that the parameter is irrelevant for generation of the service provider specific template; and
generating, based on the plurality of service provider specific parameters, a plurality of service provider specific templates for deployment and management of the computing entity over the plurality of cloud computing platforms, wherein each of the plurality of service provider specific templates includes a corresponding service provider specific parameter, from the plurality of service provider specific parameters.

2. The method as claimed in claim 1, wherein each of the plurality of service provider specific templates includes configuration information of the computing entity for cloud orchestration in a cloud computing platform, from amongst the plurality of cloud computing platforms.

3. The method as claimed in claim 1, further comprising:
executing each of the plurality of service provider specific templates; and
deploying the computing entity in each of the plurality of cloud computing platforms, in response to execution of each of the plurality of service provider specific templates.

4. The method as claimed in claim 1, wherein identifying the plurality of service provider specific parameters corresponding to the parameter further comprises:
associating the parameter to a corresponding service provider specific parameter, in response to determining that the parameter is relevant for generation of the service provider specific template.

5. The method as claimed in claim 1, further comprising:
determining availability of a set of cloud infrastructure components in each of the plurality of cloud computing platforms, prior to identifying the plurality of service provider specific parameters corresponding to the parameter; and
in response to determining that the set of cloud infrastructure components is unavailable in a cloud computing platform, from amongst the plurality of cloud computing platforms, generating a message indicating failure to generate a service provider specific template for cloud orchestration in the cloud computing platform.

6. The method as claimed in claim 1, further comprising:
associating a value with the parameter based on a user input; and
generating a message indicating an error in the user input, in response to determining that an undefined value is associated with the parameter.

7. The method as claimed in claim 1, further comprising:
generating, based on deployment cost information of each of the plurality of cloud service providers and the plurality of service provider specific templates, respective cost estimates for deployment of the computing entity in the plurality of cloud computing platforms.

8. The method as claimed in claim 1, wherein the computing entity includes one of a compute node, a storage volume, a virtual network, a virtual machine, and a resource group container.

9. The method as claimed in claim 1, wherein the plurality of parameters includes a resource information indicative of a type of computing entity to be deployed and managed, a server information indicative of capabilities of a server in which the computing entity is to be deployed, a virtual machine image information, a flavor information indicative of hardware configuration associated with the computing entity, a network configuration associated with computing entity, a security group information indicative of firewall settings associated with the computing entity, a protocol information associated with computing entity, and a combination thereof.

10. A system comprising:
a processor; and
a memory coupled to the processor, the memory storing instructions executable by the processor to:
receive a user input corresponding to a parameter from amongst a plurality of parameters indicative of information associated with a computing entity to be deployed and managed over a plurality of cloud computing platforms, wherein each of the plurality of cloud computing platforms is hosted by a cloud service provider, from amongst a plurality of cloud service providers;
determine availability of a set of cloud infrastructure components in each of the plurality of cloud computing platforms;
identify, based on the availability of the set of cloud infrastructure components, a plurality of service provider specific parameters corresponding to the parameter, wherein each of the plurality of service provider specific parameters is associated with a respective cloud service provider;
generate, based on the plurality of service provider specific parameters, a plurality of service provider specific templates for deployment and management of the computing entity over the plurality of cloud computing platforms, wherein each of the plurality of service provider specific templates includes a corresponding service provider specific parameter, from the plurality of service provider specific parameters; and
in response to determining that the set of cloud infrastructure components is unavailable in a cloud computing platform, from amongst the plurality of cloud computing platforms, generate a message indicating failure to generate a service provider specific template for cloud orchestration in the cloud computing platform.

11. The system as claimed in claim 10, wherein each of the plurality of service provider specific templates includes configuration information of the computing entity for cloud orchestration in a cloud computing platform, from amongst the plurality of cloud computing platforms.

12. The system as claimed in claim 10, wherein the processor is further to:
execute each of the plurality of service provider specific templates; and
deploy the computing entity in each of the plurality of cloud computing platforms, in response to execution of each of the plurality of service provider specific templates.

13. The system as claimed in claim 10, wherein to identify the plurality of service provider specific parameters corresponding to the parameter, the processor is further to:
determine relevance of the parameter for generation of a service provider specific template, from amongst the plurality of service provider specific templates;
associate the parameter to a corresponding service provider specific parameter, in response to determining that the parameter is relevant for generation of the service provider specific template; and
assign a default value to the parameter, in response to determining that the parameter is irrelevant for generation of the service provider specific template.

14. (canceled)

15. The system as claimed in claim 10, wherein the processor is further to:
associate a value with the parameter based on a user input; and
generate a message indicating an error in the user input, in response to determining that an undefined value is associated with the parameter.

16. The system as claimed in claim 10, further comprising:
generate, based on deployment cost information of each of the plurality of cloud service providers and the plurality of service provider specific templates, respective cost estimates for deployment of the computing entity in the plurality of cloud computing platforms.

17. The system as claimed in claim 10, wherein the computing entity includes one of a compute node, a storage volume, a virtual network, a virtual machine, and a resource group container.

18. The system as claimed in claim 10, wherein the plurality of parameters includes a resource information indicative of a type of computing entity to be deployed and managed, a server information indicative of capabilities of a server in which the computing entity is to be deployed, a virtual machine image information, a flavor information indicative of hardware configuration associated with the computing entity, a network configuration associated with computing entity, a security group information indicative of firewall settings associated with the computing entity, a protocol information associated with computing entity, and a combination thereof.

19. A non-transitory computer-readable medium comprising computer-readable instructions, the computer-readable instructions when executed by a processor, cause the processor to:
receive a user input corresponding to a parameter from amongst a plurality of parameters indicative of information associated with a computing entity to be deployed and managed over a plurality of cloud computing platforms, wherein each of the plurality of cloud computing platforms is hosted by a cloud service provider, from amongst a plurality of cloud service providers;
determine relevance of the parameter for generation of a service provider specific template, from amongst a plurality of service provider specific templates;
identify a plurality of service provider specific parameters corresponding to the parameter, each of the plurality of service provider specific parameters being associated with a respective cloud service provider, in response to determining that the parameter is relevant for generation of the service provider specific template;
assign a default value to the parameter, in response to determining that the parameter is irrelevant for generation of the service provider specific template; and
generate, based on the plurality of service provider specific parameters, a plurality of service provider specific templates for deployment and management of the computing entity over the plurality of cloud computing platforms, wherein each of the plurality of service provider specific templates includes a corresponding service provider specific parameter, from the plurality of service provider specific parameters.

20. The non-transitory computer-readable medium as claimed in claim 19, wherein each of the plurality of service provider specific templates includes configuration information of the computing entity for cloud orchestration in a cloud computing platform, from amongst the plurality of cloud computing platforms.

21. The method as claimed in claim 1, wherein the default value is null.
